(19) United States
(12) Patent Application Publication
(10) Pub. No.: US 2019/0291142 A1
(43) Pub. Date: Sep. 26, 2019

(54) FRAME CLEANING MACHINE

(71) Applicants: Sadanand Shingne, Pune (IN); Jayada Pandit, Pune (IN)

(72) Inventors: Sadanand Shingne, Pune (IN); Jayada Pandit, Pune (IN)

(21) Appl. No.: 16/439,266

(22) Filed: Jun. 12, 2019

Related U.S. Application Data
(63) Continuation of application No. PCT/IB2017/057827, filed on Dec. 12, 2017.

(30) Foreign Application Priority Data
Dec. 13, 2016 (IN) 201621042419

(51) Int. Cl. B08B 1/00; B08B 1/04; B24B 29/00

(52) U.S. Cl. CPC B08B 1/002; B24B 29/005; B08B 1/04

(57) ABSTRACT

A machine for cleaning/deburring sides of rectangular parts includes four brushes. The four brushes include a first pair of brushes adapted to clean two opposite sides of the rectangular parts and a second pair of brushes adapted to clean remaining two opposite sides of the rectangular parts. The machine also includes a mounting frame for mounting the four brushes. The four brushes are mounted on the mounting frame such that axes of rotation of the first pair of brushes and one of the brushes out of the second pair of brushes lie in a common plane, and the remaining brush of the second pair of brushes is placed offset from said common plane so that the first pair of brushes engage with complete side face without interfering with the second pair of brushes.

### CROSS-REFERENCE TO RELATED PATENT APPLICATIONS

This application is a Continuation of International Patent Application No. PCT/IB2017/057827, filed Dec. 12, 2017, which claims priority to and the benefit of Indian Patent Application No. 201621042419, filed Dec. 13, 2016. The entire disclosures of each of the foregoing applications are incorporated herein by reference in their entireties, including their specifications, claims, abstracts, and drawings.

### TECHNICAL FIELD

The present disclosure relates generally to the field of cleaning/deburring operations. In particular, the present disclosure pertains to a machine for cleaning/deburring of sides of pasted panels/plates such as those used in storage batteries.

### BACKGROUND

A burr is an unwanted material such as a raised edge remaining attached to a work piece after a process. It is usually removed by a suitable process to prevent injuries and/or to prevent undesirable effects it may have on subsequent process or during end use. Process of cleaning/deburring can account for a significant portion of manufacturing costs.

While burrs are most commonly created by machining operations, such as grinding, drilling, milling, engraving or turning, an example of burrs created on periphery of a flat work piece is dried paste of lead oxide on plates/panels of lead acid batteries. During manufacture of lead acid batteries lead panels are pasted with a mixture of lead oxide, acid and water with additives to create porosity to achieve higher efficiency. After pasting, the panels are dried before being processed further. The lead oxide paste gets dried on periphery of the panels leading to hard burrs that can cause significant damage to the performance of the battery. Also it can cause injury to the operators handling them during subsequent operations and during maintenance. They can also be detrimental to performance of the batteries as the dried paste from sides of pasted panels/plates, would eventually fall during operational use and cause unwanted short-circuit of the battery.

Cleaning of pasted panels/plates of batteries along their periphery is therefore extremely important. This cleaning process is usually carried out in small stacks consisting of 10 to 15 panels, where an operator manually holds the stack and moves the stack along its periphery against a stationary motor driving a rotating brush so that they are cleaned. Alternatively, the operator may hold the stack and scrub them with a brush along periphery of the stack. In such conventional cleaning process, it is very risky operation when done manually and much prone to accidents. Also there is no dust collection system in place and the dust generated by the cleaning process is left behind in surrounding atmosphere.

As can be seen, conventional method of cleaning panels can be extremely labor intensive, requiring significant manpower to clean hundreds of thousands of panels that are produced every shift. Further, absence of a proper dust collection system makes the working environment hazardous, posing an environmental risk that can severely affect the health of the operators.

Chinese Patent number CN101549345B discloses a device for cleaning pole plate periphery of accumulator, the device comprises a workbench; a slide-way composed of two parallel guide rails disposed on top of the workbench; a clamping mechanism for tightening a plurality of vertically arranged pole plates with pasting surfaces clung to each other is disposed inside the slide-way; a brush sheet mechanism for cleaning the pole plate periphery is disposed on end of the slide-way. When working, a first cylinder disposed in the workbench drives the clamping mechanism to perform reciprocating motion in the slide-way and the brush sheet mechanism. In the invention, vertically arranged pole plates are clamped in the clamping device and the clamping device along with the clamped pole plates performs reciprocating motion in the slide-way and the brush sheet mechanism, thus, the pole plate periphery gets cleaned. Ability of the clamping device to clamp 120-150 pieces of pole plates at one time greatly improves working efficiency, enables operator to leave the brush sheet mechanism when it is working and avoids the damage to health. The brush sheet mechanism disclosed in the above cited patent carries out cleaning in batches of pole plates that can be held in the clamping device at one time, and therefore, limits productivity.

Chinese Patent number CN103066245B discloses an automatic lug brushing, cutting and periphery brushing machine for lead acid battery plates. The disclosed multi-station machine incorporates stations for lug brushing, cutting and frame brushing and. a pole plate conveying device to move and feed the plates that automatically operates under electric control. The disclosed machine of the above cited patent carries out cleaning in multiple stages through which the plates are fed one by one and therefore process is going to be slow.

There is, therefore, a need for an improved cleaning method and device for cleaning of pasted panels of lead acid battery at a single station overcoming deficiencies of known machines.

This background description includes information that may be useful in understanding the present invention. It is not an admission that any of the information provided herein is prior art or relevant to the presently claimed invention, or that any publication specifically or implicitly referenced is prior art.

### SUMMARY

An exemplary embodiment relates to a machine for cleaning/deburring sides of rectangular parts includes four brushes. The four brushes include a first pair of brushes adapted to clean two opposite sides of the rectangular parts and a second pair of brushes adapted to clean remaining two opposite sides of the rectangular parts. The machine also includes a mounting frame for mounting the four brushes. The four brushes are mounted on the mounting frame such that axes of rotation of the first pair of brushes and one of the brushes out of the second pair of brushes lie in a common plane, and the remaining brush of the second pair of brushes is placed offset from said common plane so that the first pair of brushes engage with complete side face without interfering with the second pair of brushes.

Aspects of the present disclosure relate to a deburring/cleaning machine for cleaning sides of flat work pieces such as pasted panels/plates of storage batteries. In an aspect, the peripheral frame cleaning machine can have a single brushing station where all four sides of panels can be cleaned by brushing action before the panels fed into lug brushing/plate parting machine.

In an aspect, cleaning/deburring arrangement can include four tools—one for cleaning/deburring each side. In an exemplary embodiment involving peripheral cleaning of plates/panels of lead acid storage batteries, the tools can be brushes. There can be either two cylindrical brushes mounted horizontally, parallel to each other, or two circular/conical brushes mounted vertically such that the plane of the circle of the circular brushes faces each other with a desired gap maintained between the two for brushing top and bottom of plates/panels. Further, there can be two circular/conical brushes mounted such that the plane of the circle of the circular brushes faces each other with a desired gap maintained between them for brushing sides of plates/panels. The type of brushes and the mounting position could be suitably changed for improved performance, e.g., top and bottom brushes could be rotary flat face instead of a cylindrical variety mentioned herein.

In an aspect, axes of rotation of three brushes such as two circular/conical brushes and one of the cylindrical brush can be coplanar whereas the fourth brush i.e. second of the two cylindrical brushes can be placed at offset so that the two circular brushes engage with complete side face without interfering with the second cylindrical brush. However, the four brushes can be mounted on a single bracket on a frame making the brushing station a single station.

In an aspect, brushing operation can be done on stack of panels that are loaded vertically into in-feed conveyor of the peripheral frame cleaning machine in a continuous manner and moved through the brushing station where the sides of the stack of panels can be thoroughly cleaned of the burrs before being auto-fed into lug brushing/plate parting machine.

In an aspect, the dust generated during the cleaning process at the brushing station is suitably collected and conveyed to a dust collection unit or to a central dust collection system where the lead in the dust is extracted and recycled leading to an economic peripheral frame cleaning machine.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an exemplary isometric view of the brushing station in accordance with embodiments of the present disclosure.

FIG. 2 illustrates an exemplary front view of the brushing station in accordance with embodiments of the present disclosure.

### DETAILED DESCRIPTION

The present disclosure relates to a deburring/cleaning machine for cleaning sides of flat work pieces. It is to be appreciated that though various embodiments have been explained herein with reference to pasted panels/plates of lead acid storage batteries, they with suitable modifications that would be apparent to those skilled in art, can as well be applied to any other application requiring cleaning/deburring of sides of work pieces and all such applications and modifications are well within the scope of the present disclosure.

Embodiments explained herein relate to a peripheral frame cleaning machine for cleaning of dried paste from periphery of panels/plates, which if left there can be detrimental to life and performance of lead acid storage batteries. In an aspect, the peripheral frame cleaning machine can have a single brushing station where all four sides of panels/plates can be cleaned by brushing action before the panels fed into lug brushing/plate parting machine.

In an embodiment, the disclosed brushing machine can include four brushes—one for brushing each side wherein all the four brushes can be mounted on a single/common frame thus forming a single brushing station for cleaning all four peripheral sides of the panels/plates. There can be two cylindrical/conical/circular brushes mounted parallel either horizontally or vertically with a desired gap maintained between the two for brushing top and bottom peripheral sides of plates/panels. There can be two circular/conical brushes mounted such that the plane of the circle of the circular brushes faces each other with a desired gap maintained between them for brushing sides of plates/panels.

In an embodiment, brushes can be mounted on a single common frame such that axes of rotation of three brushes such as two circular/conical brushes and one of the cylindrical/circular/conical brush can lie in a common plane and the fourth brush i.e. second of the two cylindrical/conical/circular brushes can be placed at offset from the above plane so that the two circular brushes engage with complete side face without interfering with the second cylindrical brush.

In an embodiment, brushing operation can be done on stack of panels/plates that are loaded vertically into in-feed conveyor of the peripheral frame cleaning machine in a continuous manner and moved through the brushing station where the sides of the stack of panels can be thoroughly cleaned of the burrs before being auto-fed into lug brushing/plate parting machine.

It is to be appreciated that though embodiments of the present disclosure have been explained with reference to plates/frames of lead storage batteries, these can be used for cleaning/deburring sides of flat rectangular part, and all such applications are well within the scope of the present application without any limitations whatsoever.

A general object of the present disclosure is to provide an efficient deburring/cleaning machine for cleaning sides of flat work pieces such as the frames of pasted plates/panels of batteries along their periphery.

Another object of the present disclosure is to provide a deburring/cleaning machine that overcomes deficiencies of known machines.

Another object of the present disclosure is to provide a peripheral frame cleaning machine of pasted plates/panels that cleans plates in stacked condition and thus speeds up process of cleaning.

Another object of the present disclosure is to clean all sides of pasted panels/plates at a single station.

Yet another object of the present disclosure is to provide an environmentally healthy peripheral frame cleaning machine by incorporating a dust collection system for hazard free work environment.

Yet another object of the present disclosure is to collect lead dust during cleaning and help recycle lead contained therein.

Still another object of the present disclosure is to reduce handling of panels to optimize workforce utilization.

Reference will now be made in detail to the exemplary embodiments of the present disclosure, examples of which are illustrated in the accompanying drawings. Wherever possible, the same reference numbers are used in the drawings and the description to refer to the same or like parts. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

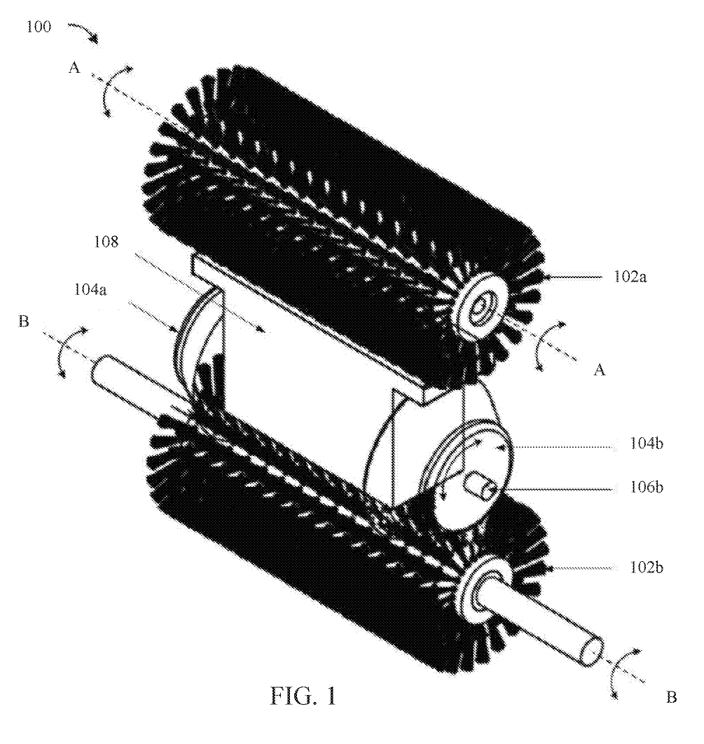

FIG. 1 illustrates an exemplary isometric view of the brushing station 100 in accordance with embodiments of the present disclosure. Shown there is an arrangement of four brushes one each for cleaning one side of plates/panels of lead acid storage batteries. The brushing station 100 can include two cylindrical brushes such as 102a and 102b (collectively referred to as 102 hereinafter) and two circular/conical brushes 104a and 104b (collectively referred to as 104 hereinafter). The first cylindrical brush 102a can be mounted either horizontally or vertically and can rotate about its axis A-A in a clockwise/anticlockwise direction. The second cylindrical brush 102b can be mounted parallel to the first cylindrical brush 102a with an appropriate distance between them and can rotate about its axis B-B in a clockwise/anticlockwise direction. These two brushes i.e. the first cylindrical brush 102a and the second cylindrical brush 102b together can brush two opposing sides of panels/plates such as tope side and bottom side.

In an embodiment, two circular brushes 104a and 104b (alternatively referred to as conical brushes in view of their conical shapes and the terms used interchangeably hereinafter) can be mounted such that their end plane i.e. plane of the circle of the circular brushes 104 is perpendicular to axes of rotation of the two cylindrical brushes 102 (i.e. A-A and B-B). The circular brushes 104a and 104b (collectively referred to as 104) can rotate in a clockwise/anticlockwise direction about their axes such as 106b of the circular brush 104b. A desired gap can be maintained between the two circular brushes 104 to allow a stack of panels 108 to pass through and the two circular brushes 104 to brush and clean two opposing sides of pasted plates/panels.

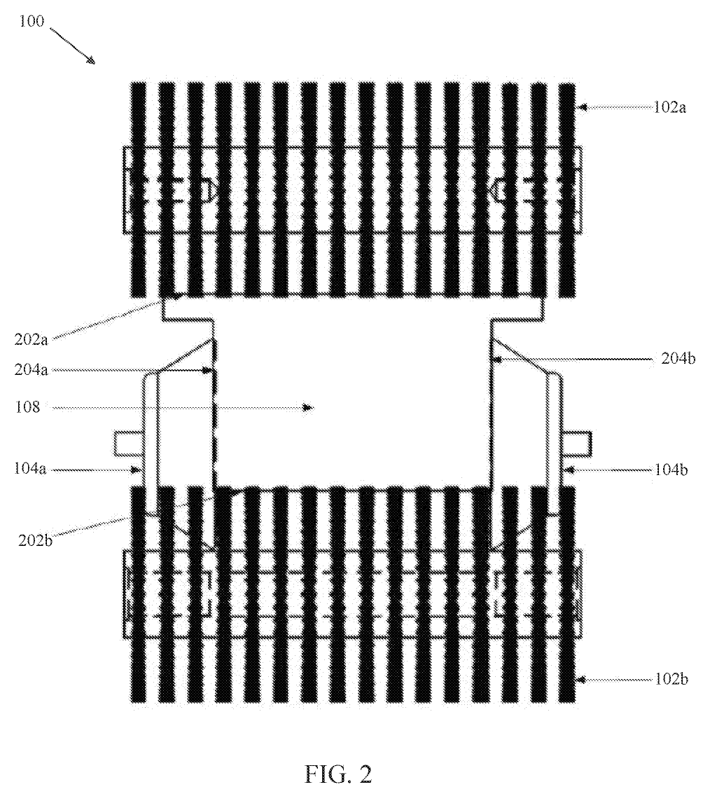

In an embodiment, one of the cylindrical brushes such as 102a and two circular brushes 104 can be mounted such that their axes of rotation lie in a common plane i.e. they are coplanar. The other cylindrical brush 102b in the instant example can be mounted away or slightly offset from the above plane. In an aspect, an offset in position of one of the cylindrical brushes avoids it interfering with the two circular brushes 104 while they engage with full length of sides of plates/panels. As can be appreciated and shown in the exemplary embodiment of FIG. 1 (and with further clarity in FIG. 2), full engagement of the circular brushes 104 with sides of panels/plates require the circular brushes 104 to project below bottom side of the panels/plates, and offset in position of the cylindrical brush 102b placed on bottom side can prevent their interfering with each other.

In an embodiment, all four brushes 102 and 104 can be mounted on a single bracket or a common frame making it a single station. In another embodiment, a feeding arrangement can feed stack of pasted plates/panels through the brushes to clean all four sides in a single go.

FIG. 2 illustrates an exemplary front view of the brushing station 100 in accordance with embodiments of the present disclosure. The figure shows a stack of panels 108 at the brushing station 100. The stack of panels 108 can have a top side 202a and a bottom side 202b (collectively referred to as horizontal sides 202 hereinafter), and left side 204a and right side 204b (collectively referred to as vertical sides 204 hereinafter). At the brushing station 100, the sides of stack of panels 108 can get cleaned by rotation of brushes 102 and 104 rubbing its surface. The rotating top and bottom cylindrical brushes 102 can rub the horizontal sides 202 i.e. top and bottom sides 202 of the stack of panels 108 respectively, and the rotating left and right side circular brushes 104 can rub the left and right sides 204 of the stack of panels 108, respectively, as shown in the figure. As such, all four sides of the stack of panels 108 can be fully cleaned at the brushing station 100, in other words, all four sides of the stack of panels 108 can be fully cleaned at a single station.

In an embodiment, pasted panels coming out of horizontal flash drying (HFD) oven can be loaded vertically into the in feed conveyor of the peripheral frame cleaning machine in a continuous manner. During its motion along the conveyor chain, the pasted panels form a solid stack. The stack of panels 108 can be moved through the brushing station 100. As the stack of panels 108 can be passing through the brushing station 100, the top side 202a, left and right sides 204 of the stack of panels 108 can be thoroughly cleaned as rotating brushes continuously rub them as described above. As the stack of panels 108 move further on the conveyor chain, the bottom side 202b of the stack of panels 108 can be cleaned by the bottom cylindrical brush 102b that is mounted slightly offset. As such, all four sides 202 and 204 of the stack of panels 108 can be thoroughly clean, with all burrs removed, when the stack of panels 108 comes out of the brushing station 100.

In an embodiment, the stack of panels 108 with its sides cleaned and continuously moving on the conveyor chain, can be moved along the out feed conveyor of the peripheral frame cleaning machine and can be auto-fed into lug brushing/plate parting machine.

In an embodiment, the stack of panels 108 is cleaned before being auto-fed into lug brushing/plate parting machine. This ensures that operators are not hurt by burrs on the periphery of the stack of panels 108 in case they handle them.

In an embodiment, the dust generated during the cleaning process at the brushing station 100 can be suitably collected through an exhaust system and can be further connected to dust collection units or to a central dust collection system of the facility where the lead in the dust can be extracted and recycled. As such, a tidier and hazard free working environment is extremely important for the health and safety of the operators. Recycling of the lead can result in an economically advantageous peripheral frame cleaning machine.

In an embodiment, peripheral frame cleaning machine can be fully automated and therefore would not need continuous presence of an operator. As such, the disclosed peripheral frame cleaning machine can be extremely economical to operate.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

As will be appreciated by those reviewing the present disclosure, numerous advantages may be attained using the concepts disclosed herein. For example, the present disclosure provides an efficient deburring/cleaning machine for cleaning sides of flat work pieces such as pasted plates/panels of batteries along their periphery, which overcomes deficiencies of known machines.

The present disclosure provides a peripheral frame cleaning machine of pasted plates/panels that cleans frames of pasted plates/panels in stacked condition and thus speeds up process of cleaning.

The present disclosure provides a peripheral frame/plate cleaning machine that cleans all sides of pasted panels/plates at a single station.

The present disclosure provides an environmentally healthy peripheral frame cleaning machine by incorporating a dust collection system for hazard free work environment.

The present disclosure provides extraction of lead from dust collected during cleaning and recycle lead contained therein.

The present disclosure reduces handling of panels to optimize workforce utilization.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

In some embodiments, the numbers expressing quantities of ingredients, properties such as concentration, reaction conditions, and so forth, used to describe and claim certain embodiments of the invention are to be understood as being modified in some instances by the term “about”. Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms are used herein. To the extent a term used in a claim is not defined, it should be given the broadest definition persons in the pertinent art have given that term as reflected in printed publications and issued patents at the time of filing.

Unless the context requires otherwise, throughout this specification, the word “comprise” and variations thereof, such as, “comprises” and “comprising” are to be construed in an open, inclusive sense that is as “including, but not limited to.”

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The headings and abstract provided herein are for convenience only and do not interpret the scope or meaning of the embodiments.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

What is claimed is:

1. A machine for cleaning/deburring sides of rectangular parts, the machine comprising:
four brushes, said four brushes comprising a first pair of brushes adapted to clean two opposite sides of the rectangular parts and a second pair of brushes adapted to clean remaining two opposite sides of the rectangular parts; and
a mounting frame for mounting the four brushes;
wherein the four brushes are mounted on the mounting frame such that axes of rotation of the first pair of brushes and one of the brushes out of the second pair of brushes lie in a common plane, and the remaining brush of the second pair of brushes is placed offset from said common plane so that the first pair of brushes engage with complete side face without interfering with the second pair of brushes.

2. The machine as claimed in claim 1, wherein the first pair of brushes comprises either two mutually parallel cylindrical brushes, or two conical or circular brushes, wherein the first pair of brushes is adapted to clean two opposite sides of the rectangular parts by maintaining appropriate spacing between the two brushes of the first pair of brushes.

3. The machine as claimed in claim 1, wherein the second pair of brushes comprises two circular or conical brushes mounted with their flat faces facing each other, wherein the second pair of brushes is adapted to clean remaining two opposite sides of the rectangular parts by maintaining appropriate spacing between the two brushes of the second pair of brushes.

4. The machine as claimed in claim 1, wherein the mounting frame forms a single peripheral cleaning/deburring station for peripheral cleaning/deburring of the rectangular parts.

5. The machine as claimed in claim 4, the machine configured such that the rectangular parts may be loaded vertically into an in-feed conveyor in a continuous manner and moved through the peripheral cleaning/deburring station.

6. The machine as claimed in claim 1, wherein the rectangular parts are plates/panels of lead acid storage batteries, and the machine cleans/deburrs dried paste of lead oxide on the plates/panels.

7. The machine as claimed in claim 6, wherein the machine further includes an exhaust system to collect lead oxide dust generated during the cleaning/deburring and convey the dust to a central dust collection system for lead recovery.
